(19) United States
(12) Patent Application Publication
(10) Pub. No.: US 2013/0305543 A1
(43) Pub. Date: Nov. 21, 2013

(54) SCISSORS

(71) Applicant: PLUS CORPORATION, Tokyo (JP)

(72) Inventors: Yusuke YONETSU, Tokyo (JP); Naoya YOSHIDA, Tokyo (JP)

(73) Assignee: PLUS CORPORATION, Tokyo (JP)

(21) Appl. No.: 13/895,532

(22) Filed: May 16, 2013

(30) Foreign Application Priority Data
May 18, 2012 (JP) 2012-114335

(51) Int. Cl. B26B 13/06

(52) U.S. Cl. CPC B26B 13/06
USPC 30/254

(57) ABSTRACT

Scissors are provided wherein in a curved shape of cutting blades, assuming that when the scissors are opened, a distance between an intersection point where the left and right cutting blades intersect and a rotational center is Y, a line connecting the intersection point where the left and right cutting blades intersect and the rotational center is a rotation reference line B, a distance from the rotational center of the scissors to fixed points A on the left and right cutting blades is R (mm), an angle at which a line connecting the fixed point A on one of the cutting blades and the rotational center intersects the rotation reference line B is θ (rad), and an angle which is formed by tangents touching the fixed points A on the left and right cutting blades is X (rad), the shape of the cutting blades is expressed by a polar equation:

R=Y*exp(θ*Cot(X/2)).

### CROSS-REFERENCE TO RELATED APPLICATION

This application is based upon and claims the benefit of priority under 35 USC 119 from Japanese Patent Application No. 2012-114335 filed on May 18, 2012, the entire contents of which are incorporated herein by reference.

### FIELD

The present invention relates to scissors for cutting various types of paper, tape and cloth in offices or at general homes.

### BACKGROUND

Currently, it is desired that scissors for use in offices or at homes are given such sizes and weights that enable female persons and children to use them with one hand easily and can be opened and closed lightly with distal parts of fingers including a thumb to cut various types of paper and cloth easily.

Because of this, various proposals have been made which enhance the cutting capability and facilitate the opening and closing of blade portions of scissors with fingers including a thumb of either hand. Various surface treatments have been proposed and put into practical use. For example, in one proposal, a ceramic coating is applied to blade portions (for example, KOKAI (Japanese Unexamined Patent Publication) No. 05-096065), and in another proposal, a coating layer made of extremely hard abrasive grains is provided on blade portions (for example, KOKAI (Japanese Unexamined Patent Publication) No. 2005-168625).

In addition, in order to prevent the occurrence of a situation in which an object to be cut is caught between two blade portions of scissors, making it difficult to cut it, in one proposal, a gap is formed between back sides of the two blade portions (for example, KOKAI (Japanese Unexamined Patent Publication) No. 2001-314669), in another proposal, the shape of a space called a “back gap”(called as “Urasuki” in Japanese) or a “recess” (called as “Hizoko” in Japanese) which is formed in back sides of blade portions is improved (for example, KOKAI (Japanese Unexamined Patent Publication) No. 2003-062369), and in a further proposal, a method for forming the “back gap” is proposed. Scissors to which these techniques are applied are put into practical use in reality.

With conventional scissors, however, when a cardboard or the like is cut, although a large magnitude of force can be applied to roots of two cutting blades, an opening angle formed between the two blades becomes large, and an object to be cut is allowed to move so as to escape from the roots to tips of the cutting blades, whereby resulting from time to time in a situation in which the object cannot be cut. Thus, users have had difficulty in cutting an object to be cut with a small force from time to time.

### SUMMARY

The invention has been made to eliminate the problem inherent in the conventional scissors, and an object thereof is to provide scissors which can cut an object to be cut easily in a stable condition by using cutting blades from roots to tips thereof.

According to an aspect of the invention, there is provided scissors wherein in a curved shape of cutting blades of the scissors, assuming that when the scissors are opened, a distance between a point of intersection where left and right cutting blades intersect and a rotational center is Y, a line connecting the point of intersection where the left and right cutting blades intersect and the rotational center is a rotation reference line B, a distance from the rotational center of the scissors to fixed points A on the left and right cutting blades is R (mm), an angle at which a line connecting the fixed point A on one of the cutting blades and the rotational center intersects the rotation reference line B is θ (rad), and an angle which is formed by tangents touching the fixed points A on the left and right cutting blades is X (rad), the shape of the cutting blades is expressed by a polar equation:

R=Y*exp(θ*Cot(X/2)),

and wherein
the X takes values in the range from π/18 (rad) to π/3 (rad), and the Y takes values in the range from 5 (mm) to 30 (mm) when the left and right cutting blades are opened to a maximum extent in such a state that the left and right cutting blades intersect.

In addition, in the scissors, a maximum value of the R is 200 (mm)

In the invention, the distance R from the rotational center of the scissors to the fixed points A on the left and right butting blades is specified by the angle θ at which the line connecting the fixed point A on the one of the cutting blades and the rotational center intersects the rotation reference line B which is a center line of the opened scissors and the angle X at which the left and right cutting blades intersect. Additionally, the polar equation which expresses the shape of the cutting blades is expressed as R=Y*exp(θ*Cot(X/2)). Therefore, however widely or narrowly the scissors may be opened, the angle at which the cutting blades intersect remains the same. Thus, with the scissors of the invention, a constant cutting quality can be provided from base portions to tips of the cutting blades, whereby the scissors can constantly cut an object to be cut well.

In addition, in the scissors, the maximum value of the distance R to the fixed points A on the cutting blade is 200 (mm) Therefore, the scissors can be provided which even female persons or children can easily use with either hand thereof.

### BRIEF DESCRIPTION OF THE DRAWINGS

FIG. 1 is a front view of scissors for office use according to an embodiment of the invention showing a state in which the scissors are closed.

FIG. 2 is a front view of the scissors for office use according to the embodiment of the invention showing a state in which the scissors are opened slightly.

FIG. 3 is a front view of the scissors for office use according to the embodiment of the invention showing a state in which the scissors are opened.

FIG. 4 is a side view of the scissors for office use according to the embodiment of the invention showing a state in which the scissors are closed.

FIG. 5 is a rear view of the scissors for office use according to the embodiment of the invention showing how blades are superimposed when the scissors are closed.

FIG. 6 is a rear view of scissors for office use according to another embodiment of the invention in which blades intersect at a different angle, showing how the blades are superimposed when the scissors are closed.

### DETAILED DESCRIPTION

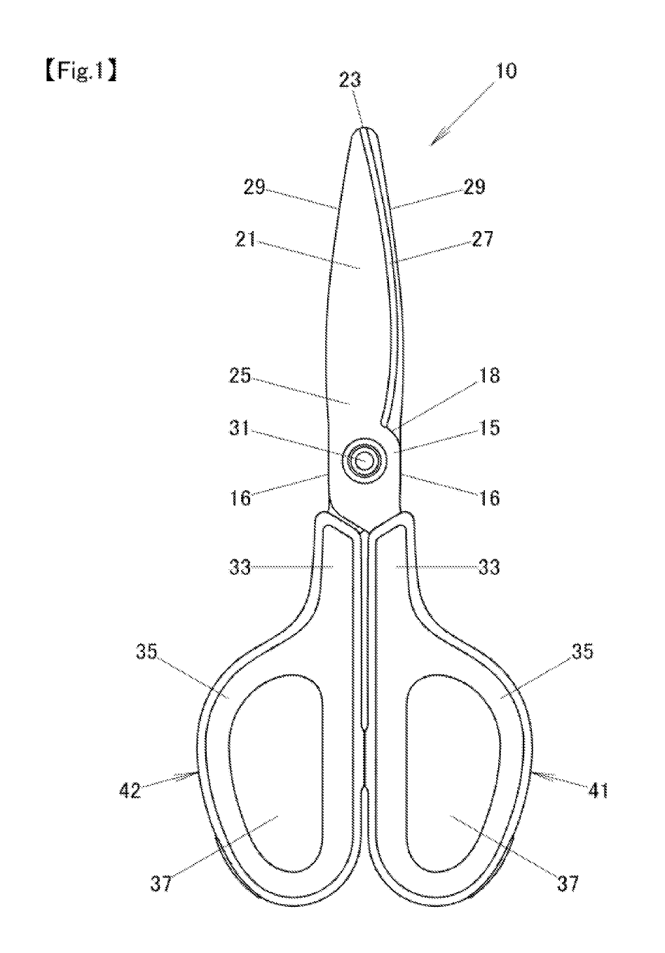

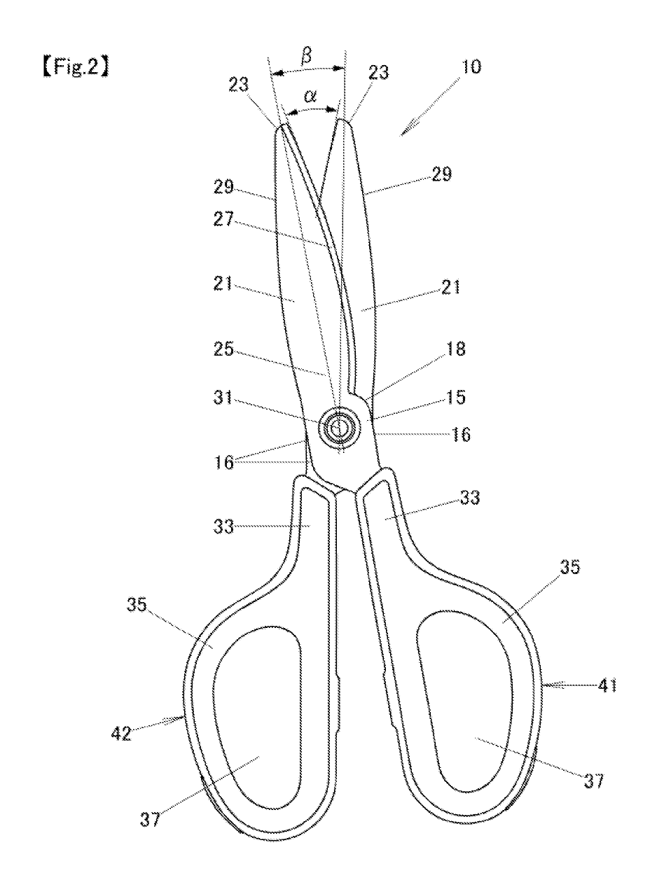

As shown in FIGS. 1 and 2, in scissors according to an embodiment of the invention, a cutting blade 27 formed on a blade portion 21 has a curvilinear shape. Additionally, a receding portion 18 is formed at a base portion 25 of the blade portion 21, and in this receding portion 18, an end portion of the cutting blade 27 which lies at the base portion 25 is caused to recede further away from a side edge 16 of a connecting portion 15 which connects a handle portion 33 including a grip portion 35 and the blade portion 21.

In the curvilinear shape of the cutting blade 27, the curvature of the cutting blade 27 is not constant from a tip 23 to the base portion 25 of the blade portion 21. In left and right blade portions 21, the curvature of the cutting blade 27 is changed so that a radius of curvature gradually decreases from a tip 23 end towards a base portion 25 end thereof or so that the curvature gradually increases towards the base portion 25 end.

In the scissors 10, the grip portion 35 having a finger/thumb hole 37 is integrated with the connecting portion 15 via the handle portion 33, and the connecting portion 15 has a screw as a joint member 31, whereby a first scissor member 41 and a second scissor member 42 are connected together so as to rotate relative to each other. In the first scissor member 41 and the second scissor member 42, the elongated plate-shaped blade portion 21 is provided so as to extend from the connecting portion 15. One side of the blade portion 21 is formed into the cutting blade 27 and the other side is formed into a back portion 29.

The back portion 29 of the blade portion 21 is formed into a smooth curve that is close to a straight line and which has a large radius of curvature and extends continuously from the tip 23 of the blade portion 21 to the side edge 16 of the connecting portion 15. In addition, the cutting blade 27 of the blade portion 21 is curved so that the width thereof is increased at an intermediate portion between the tip 23 and the base portion 25 thereof. The cutting blade 27 at the base portion 25 of the blade portion 21 is caused to recede further away from the side edge 16 of the connecting portion 15, and the receding portion 18 is formed in a position lying near the end portion of the cutting blade 27 which lies at the base portion.

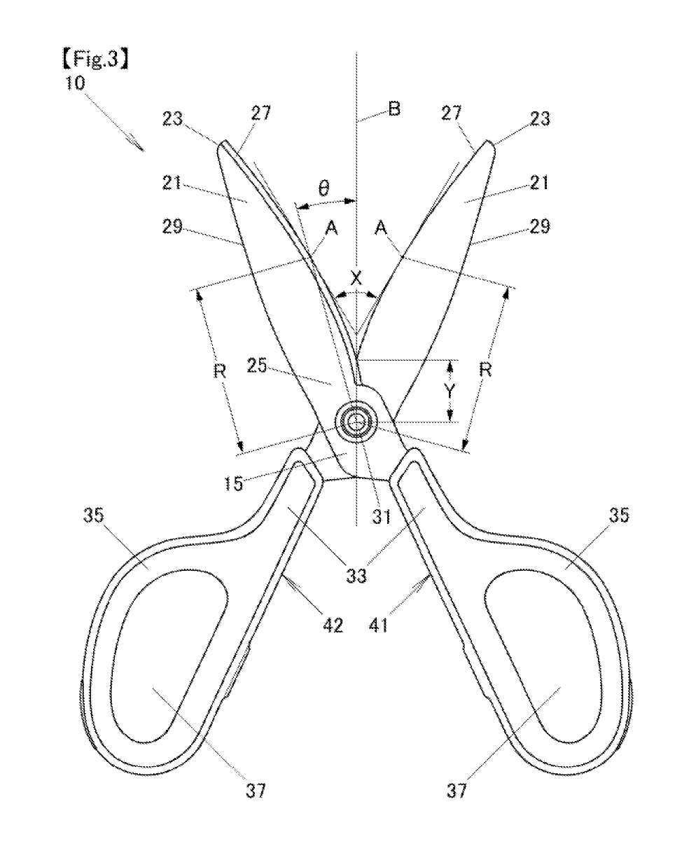

In this way, the cutting blade 27 has the curved shape in which the radius of curvature decreases more at the base portion 25 end than at the tip 23 end of the blade portion 21, that is, the curvature increases gradually from the tip 23 towards the base portion 25. The curvature is changed so that when assuming that when the first scissor member 41 and the second scissor member 42 are opened so that the left and right blade portions 21 are opened to a predetermined width as shown in FIG. 3, a distance between a point of intersection where the left and right cutting blades 27 intersect and a rotational center is Y, a line connecting the point of intersection where the left and right cutting blades 27 intersect and the rotational center is a rotation reference line B, a distance from the rotational center of the scissors 10 to fixed points A on the left and right cutting blades 27 is R (mm), an angle at which a line connecting the fixed point A on one of the cutting blades 27 and the rotational center intersects the rotation reference line B is θ (rad), and an angle which is formed by tangents touching the fixed points A on the left and right cutting blades 27 is X (rad), a polar equation which expresses the shape of the cutting blades 27 satisfies a conditional expression:

R=Y*exp(θ*Cot(X/2)).

In this way, by defining the distance R from the rotational center to the fixed points A on the cutting blades 27, the angle θ at which the line connecting the fixed point A and the rotational center intersects the rotation reference line B and the angle X/2 at which the tangent touching the fixed point A intersects the rotation reference line B, even though the position where the cutting blade 27 of the first scissor member 41 and the cutting blade 27 of the second scissor member 42 intersect changes from the base portions 25 to the tips 23 of the blade portions 21, an angle a at which both the cutting blades 27 intersect each other can be kept constant.

Namely, although an opening angle 13 between the blade portion 21 of the first scissor member 41 and the blade portion 21 of the second scissor member 42 changes, the angle a at which both the cutting blades 27 intersect each other can be kept constant at all times.

Additionally, the angle X at which the tangents touching the fixed points A on both the cutting blades 27 intersect each other takes values in the range from π/18 (rad) to π/3 (rad), and the distance Y from the rotational center to the position where both the cutting blades 27 intersect each other when the left and right cutting blades 27 are opened to a maximum extent in such a state that the left and right cutting blades 27 intersect each other, that is, the distance Y from the rotational center to the end portion of the cutting blade 27 which lies at the base portion 25 takes values in the range from 5 (mm) to 30 (mm)

In the event that the value of the angle X at which the tangents touching the fixed points A on both the cutting blades 27 intersect each other becomes smaller than π/18 (rad), a space defined between the blade portion 21 of the first scissor member 41 and the blade portion 21 of the second scissor member 42 when the blade portions 21 of the scissors 10 are opened becomes small, and it becomes difficult to hold an object to be cut such as paper or cloth therebetween, which is not preferable.

When the value of the angle X becomes larger at which the tangents touching the fixed points A on both the cutting blades 27 intersect each other, the curvature of the cutting blades 27 increases. Because of this, in the event that the value of the angle X becomes larger than π/3 (rad) with the length of the cutting blades 27 kept constant, a distance between the back portion 29 and the cutting blade 27 which constitutes a width of the blade portion 21 at an intermediate position thereof is increased, resulting in a special shape in which the width of an intermediate portion of the blade portion 21 becomes wide. This special shape is different from the shape of general scissors 10 which is familiar to users, causing a sensation of physical disorder, which is not preferable.

Because of this, the angle X at which the tangents touching the fixed points A on both the cutting blades 27 intersect each other should be in the range from π/18 (rad) to π/3 (rad), and more preferably, the angle X should be in the range from π/12 (rad) to π/5 (rad).

In addition, in the event that the value of the distance Y from the rotational center of the blade portion 21 to the end portion of the cutting blade 27 which lies at the base portion 25 is equal to or smaller than 5 (mm), in the normal scissors 10 which is used with one hand, it becomes difficult to join the first scissor member 41 and the second scissor member 42 together at the connecting portions 15 thereof in a durable fashion. On the other hand, in the event that the value of the distance Y exceeds 30 (mm), the effective length of the cutting blades 27 becomes short, and the user has difficulty in using the scissors 10 with the cutting blades 27 whose effective length is so short.

Consequently, in order to realize scissors 10 which are easy to be used in a state in which the scissors 10 are opened to a maximum extent with fingers including a thumb put through finger/thumb rings 37 thereof, it is preferable that the distance Y from the rotational center of the blade portion 21 to the end portion of the cutting blade 27 which lies at the base portion 25 is substantially in the range from 5 (mm) to 15 (mm).

In addition, by setting a distance from the rotational center to the tip 23 of the blade portion 21 to a maximum (Rmax) of 200 (mm), the scissors 10 are so sized as to be easily handled by a female person or a child.

Additionally, in the scissors 10 shown in FIGS. 2 and 3, the angle at which both the cutting blades 27 cross when the cutting blades 27 are caused to intersect each other is set to be π/6 (rad).

In this way, by setting the angle at which both the cutting blades 27 cross to π/6 (rad), an object to be cut can easily be cut when the object is attempted to be cut at deep portions of the blade portions 21.

Namely, when an object to be cut is cut with the scissors 10, the object is cut by a combination of shearing and cutting. As the angle at which the cutting blades 27 cross becomes smaller, a ratio of shearing becomes higher, and as the angle at which the cutting blades 27 cross becomes larger, a ratio of cutting becomes higher. When the angle at which the cutting blades 27 cross is of the order of π/6 (rad), the ratio of shearing becomes equal to the ratio of cutting, and the cutting blades 27 are allowed to cut into an object to be cut such as paper without the object escaping towards tips of the cutting blades 27. Thus, the object to be cut can be cut through the combination of shearing and cutting by closing the scissors 10 with a small force.

Additionally, with the scissors 10 of this embodiment, since the angle at which both the cutting blades 27 cross stays the same from the base portions 25 to the tips 23, the object to be cut can be cut easily through cutting without the ratio of cutting to shearing being reduced not only when the object is cut at the base portion 25 ends of the blade portions 21 but also when the object is cut at the tip 23 ends of the blade portions 21. Consequently, the object to be cut can be cut easily in a constant stable condition from the base portions 25 to the tips 23 of the blade portions 21.

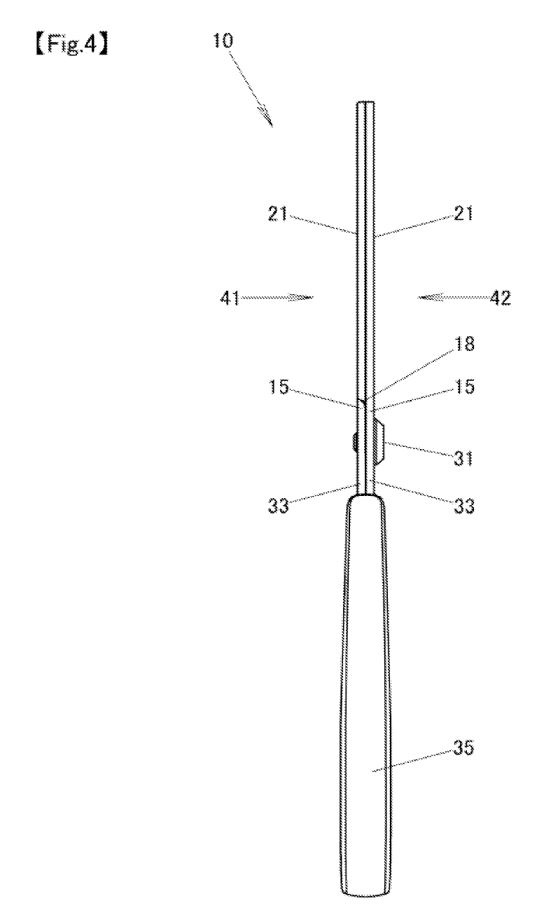

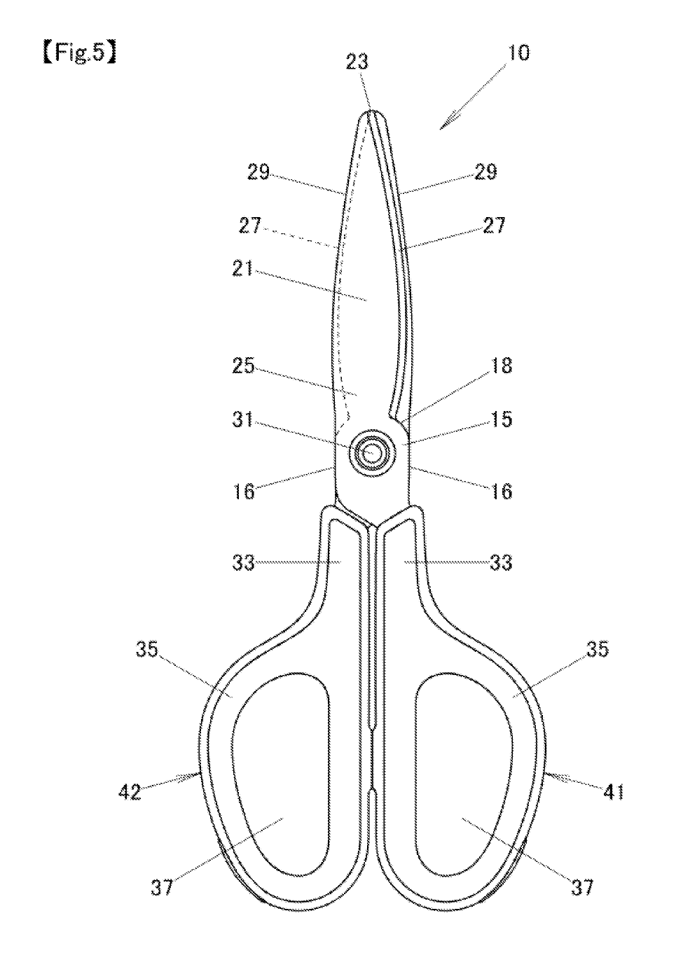

As shown in FIGS. 4 and 5, the blade portions 21 of the first scissor member 41 and the second scissor member 42 have the same shapes, and the blade portions 21 having the same shapes are connected to each other rotatably at the connecting portions 15 by the joint member 31 in a symmetrical fashion. Then, both the blade portions 21 have the receding portion 18 between the base portion of the cutting blades 27 and the side edge 16 of the connecting portion 15, and the back portion 29 of each of the blade portions 21 is so shaped as to be smoothly connected to the side edge 16 of the connecting portion 15. Additionally, when the scissors 10 are closed, the blade portion 21 of the first scissor member 41 and the blade portion 21 of the second scissor member 42 are superimposed one on top of the other so that the cutting blade 27 of the blade portion 21 of the second scissor member 42 is situated further inwards than the back portion 29 of the blade portion 21 of the first scissor member 41, whereby the user is prevented from touching the cutting blade 27 inadvertently.

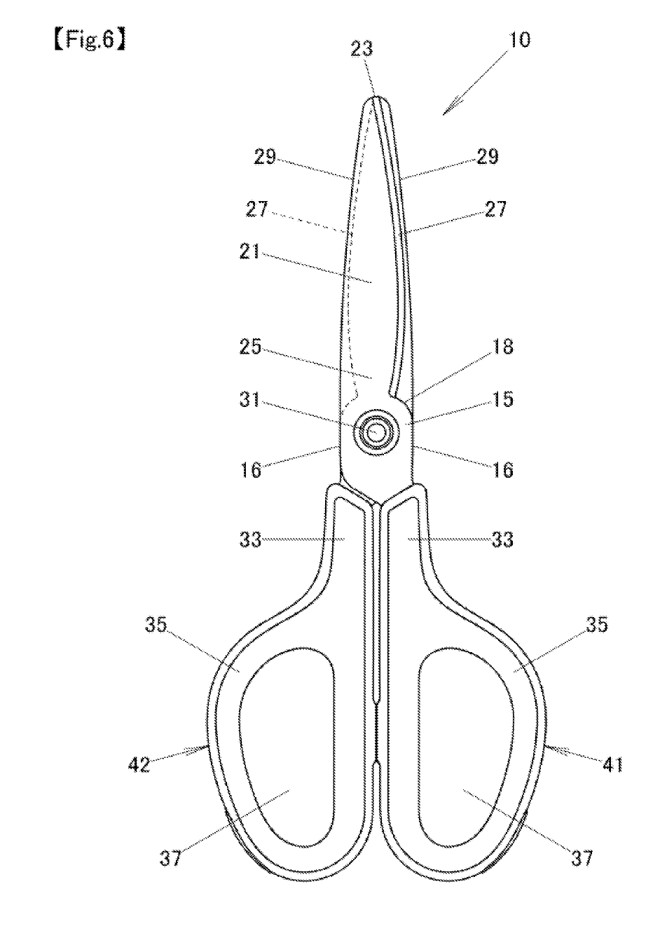

In scissors 10 according to another embodiment in which an angle X at which tangents touching fixed points A on both cutting blades 27 intersect each other is set to be π/7 (rad), as shown in FIG. 6, the cutting blades 27 are curved slightly less sharply than those of the scissors 10 shown in FIG. 5, and the width of blade portions 21 resulting when a first scissor member 41 and a second scissor member 42 are closed can be made narrower.

In the embodiments described above, while the first scissor member 41 and the second scissor member 42 are integrated with each other rotatably by the screw as the joint member 31, a fixture such as a machine screw or a rivet can be used as required as the joint member 31, provided that the first scissor member 41 and the second scissor member 42 can be connected to each other rotatably.

Further, a ceramic or titanium coating can be applied to the blade portions 21 or a recess (called as “Hizoko” in Japanese) can be formed on the back sides of the blade portions 21, whereby the scissors 10 can be produced which have the blade portions 21 with a better cutting quality.

In this way, in the scissors 10 for office use according to the invention, the cutting blades 27 are curved so that the width becomes widest at the intermediate portions of the blade portions 21. As the curved shape of the cutting blades 27, the curvature is changed so as to gradually increase from the tip 23 towards the base portion 25, and the blade portions 21 are each shaped so that the end portion of the blade portion 21 which lies as the base portion is caused to recede further inwards than the side edge 16 of the connecting portion 15, whereby the object to be cut can easily be cut in a stable condition by using the blade portions 21 from the base portions 25 to the tips 23.

While the embodiment and the modified examples have been described heretofore, they are illustrated as the examples of the invention and hence are not intended to limit the spirit and scope of the invention. The novel embodiment including the modified examples can be carried out in other various forms, and various omissions, replacements and modifications can be made thereto without departing from the spirit and scope of the invention. Those resultant embodiments and modifications are to be included in the spirit and scope of the invention and are also included in the scopes of inventions claimed and their equivalents.

What is claimed is:

1. Scissors comprising:
a first scissor member and a second scissor member each including a cutting blade on an inner side of a blade portion and which are connected to each other rotatably at connecting portions,
wherein in a curved shape of cutting blades of the scissors, assuming that when the scissors are opened:
a distance between a point of intersection where left and right cutting blades intersect and a rotational center is Y;
a line connecting the point of intersection where the left and right cutting blades intersect and the rotational center is a rotation reference line B;
a distance from the rotational center of the scissors to fixed points A on the left and right cutting blades is R (mm);
an angle at which a line connecting the fixed point A on one of the cutting blades and the rotational center intersects the rotation reference line B is θ (rad); and
an angle which is formed by tangents touching the fixed points A on the left and right cutting blades is X (rad),
wherein the shape of the cutting blades is expressed by a polar equation:
R=Y*exp(θ*Cot(X/2)),
and
wherein the X takes values in the range from π/18 (rad) to π/3 (rad), and the Y takes values in the range from 5 (mm) to 30 (mm) when the left and right cutting blades are opened to a maximum extent in such a state that the left and right cutting blades intersect.

2. The scissors according to claim 1, wherein a maximum value of the R is 200 (mm)
